(19) United States
(12) Patent Application Publication
(10) Pub. No.: US 2007/0161265 A1
(43) Pub. Date: Jul. 12, 2007

(54) Rubber spring connector

(75) Inventor: Sung-Lai Wang, Wu Gu Shiang (TW)

Correspondence Address: BACON & THOMAS, PLLC, 625 SLATERS LANE, FOURTH FLOOR, ALEXANDRIA, VA, 22314, US

(73) Assignee: Lih Duo International Co., Ltd., Wu Gu Shiang (TW)

(21) Appl. No.: 11/327,332

(22) Filed: Jan. 9, 2006

(51) Int. Cl. H01R 12/00

(52) U.S. Cl. 439/66

(57) ABSTRACT

A rubber spring connector with characteristic of extended and repeated use in electrical connection with electric components has an insulating flexible silicone rubber layer which is embedded with a conductive spring matrix composed of a group of conductive spring modules in longitudinal and latitudinal matrix arrangement.

### BACKGROUND OF THE INVENTION

1. Field of the Invention

The present invention relates to a rubber spring connector, more particularly to a rubber connector having a conductive spring matrix.

2. Description of the Prior Art

As illustrated in FIG. 1, the prior used rubber connector 10 comprises a group of fine-interval gold-plated conductive wires arranged as a conductive wire matrix 15 and embedded in an insulating flexible silicone rubber layer 11. Each gold-plated conductive wire in the conductive wire matrix 15 projected a few micrometers out of the top and bottom of the flexible silicone rubber layer 11 of the rubber connector 10.

The rubber connector 10 has such distinguished functions as high conductivity, resistant to high and low heat, resistant to aging process and easy for machining, which industrial application is manufactured as a conductive contact pads capably applied in electrical connection for any keystroke of computer keyboards, telephone, remote control unit or mobile phone etc. or applied in IC test purposes.

Therefore, the prior used rubber connector 10 is actually an electrical connecting device for the purpose of enabling an isolated or obstructed circuit be electrically connected as an entire current circuit to have the circuit be capable of developing its anticipated performance only by current flowed into the circuit via the conductive wire matrix 15 of rubber connector 10.

For example, the rubber connector 10 as shown in FIG. 3 is used as a bridge for electrical connection which enables the electronic component 30 and the printed circuit board 40 become in electrical connection to develop anticipated performance or functions derived from in connection with the electronic component 30 and the printed circuit board 40.

However, each gold-plated conductive wire in the conductive wire matrix 15 of the prior used rubber connector 10 is quite delicate and sophisticated, but with its flexibility being not enough. Although the conductive wire matrix 15 is embedded in and protected by the insulating flexible silicone rubber layer 11, once the flexible silicone rubber layer 11 is subjected to impact or collision pressure, each gold-plated conductive wire in the conductive wire matrix 15 could easily be dislocated or bent, resulting in poor flexibility.

Therefore, the shortcoming of such prior used rubber connector 10 is the vulnerability of gold-plated conductive wire which, even protected by the insulating flexible silicone rubber layer 11, could easily be dislocated and bent. For avoiding deformation to the gold-plated copper wires, the user should be very careful to ensure consistent pressure forced on the flexible silicone rubber layer 11 of the rubber connector 10. After extended and repeated use of such prior used rubber connector 10, the electrical connection provided from the rubber connectors shall be inconsistent or distorted due to the gold-plated conductive wires of the rubber connector being deformed in use.

### SUMMARY OF THE INVENTION

The primary objective of this invention is to provide a rubber spring connector having an insulating flexible silicone rubber layer embedded with a conductive spring matrix composed of conductive spring modules in longitudinal and latitudinal matrix arrangement. When the insulating flexible silicone rubber layer of the rubber spring connector is subjected to impact or colliding pressure, the flexible buffer effect of the conductive spring module shall prevent dislocation or bending.

Due to conductive spring module provided with better flexibility, the rubber spring connector of the present invention has the characteristic of extended and repeated use.

Particularly, when in actual use, even when the flexible silicone rubber layer of rubber spring connector of the invention is subjected to inconsistent pressure, the conductive spring module of the rubber spring connector by itself flexibility and resiliency will perform compensation and enable the rubber spring connector of the invention provide with a reliable and consistent electrical connection.

### BRIEF DESCRIPTION OF THE DRAWINGS

FIG. 1 is an enlarged view of a prior used rubber connector.

FIG. 2 is an enlarged view of a rubber spring connector of the present invention showing the rubber spring connector installed with conductive spring matrix.

FIG. 3 is a schematic view of the prior used rubber connector shown in FIG. 1 in practical operation status.

FIG. 4 is a schematic view of the rubber spring connector of the present invention shown in FIG. 2 in practical operation status.

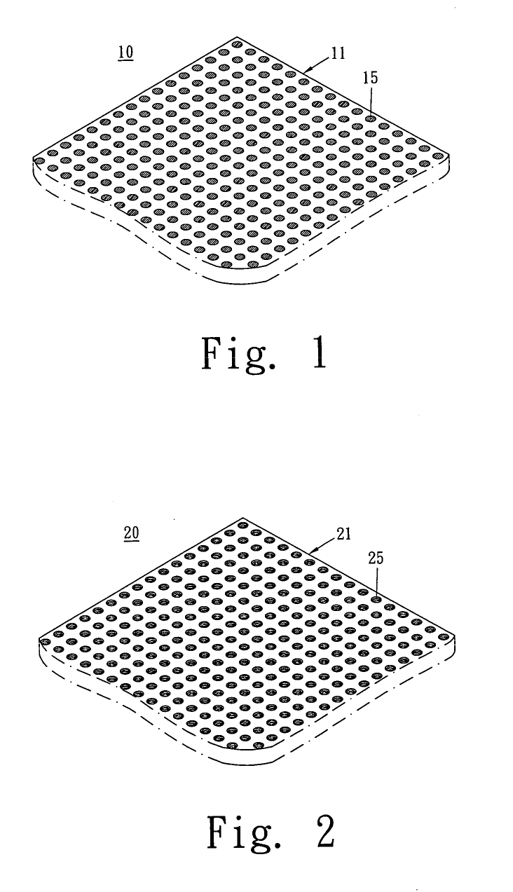

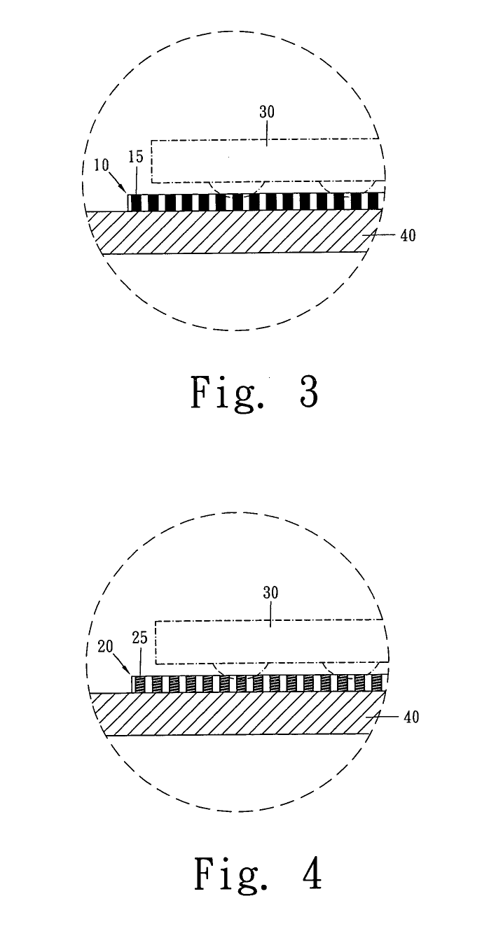

### DESCRIPTION OF THE PREFERRED EMBODIMENT

As shown in FIG. 2, a rubber spring connector 20 of the present invention has an insulating flexible silicone rubber layer 21 already embedded with a conductive spring matrix 25 composed of a group of conductive spring modules arranged in longitudinal and latitudinal matrix arrangement, and each conductive spring module in the conductive spring matrix 25 is slightly projected about a few micrometers from the top and bottom of the flexible silicone rubber layer 21.

The rubber spring connector 20 of the present invention serves as a functional connector which enables an isolated or obstructed circuit be connected as an entire current circuit to have current flowed into the circuit via the conductive spring matrix 25 of the rubber spring connector 20.

In particular, when the insulating flexible silicone rubber layer 21 of the rubber spring connector 20 is impacted by an outside force or collision, each conductive spring module in the conductive spring matrix 25 of the rubber spring connector 20 provide a buffer effect to absorb the outside force or collision by compressed distortion and to resume their original position by elastic extension once the outside impact or collision has disappeared.

Therefore, each conductive spring module in the conductive spring matrix 25 of the rubber spring connector 20 will not be dislocated or bent by an outside force or collision, and will be capable of maintaining their original performance after extended and repeated use.

As shown in FIG. 4, when the rubber spring connector 20 of the invention is used as a connector between an electronic component 30 and a printed circuit board 40, and if it exists inconsistent pressure being applied on different parts of the flexible silicone rubber layer 21 of the rubber spring connector 20, even resulting in the flexible silicone rubber layer 21 of rubber spring connector 20 is in failure of completely close contact between the electronic component 30 or the printed circuit board 40, some minute extension or compression effect derived from the related conductive spring modules of the rubber connector 20 is capable of performing compensation, particularly enabling a firm contact between the conductive spring matrix 25 of the rubber spring connector 20 and the circuit contact points of the electronic component 30 or the printed circuit board 40, thereby achieving proper and consistent electrical connection, and enabling anticipated performance in connection with the electronic component 30 and the printed circuit board 40.

The contents disclosed above relate to a preferred embodiment of the present invention. It is to be understood that all equivalent modifications, variations, improvement or changes that are easily made by skillful people in the trade and without departing from the spirit of the above contents and drawings should be included in the subject claim.

1. A rubber spring connector comprising an insulating flexible silicone rubber layer embedded with a conductive spring matrix composed of a group of conductive spring modules in longitudinal and latitudinal matrix arrangement.

2. The rubber spring connector according to claim 1, wherein said conductive spring modules project from a top and bottom of said flexible silicone rubber layer.

3. The rubber spring connector according to claim 1, wherein said conductive spring modules comprise electrically conductive springs.

4. A connector, comprising:
an insulating flexible silicone rubber layer;
a conductive spring matrix embedded within said insulating flexible silicone rubber layer, the conductive spring matrix comprising a group of electrically conductive spring modules in longitudinal and latitudinal matrix arrangement, said electrically conductive spring modules projecting from top and bottom surfaces of said flexible silicone rubber layer.
